(19) United States
(12) Patent Application Publication
(10) Pub. No.: US 2012/0324507 A1
(43) Pub. Date: Dec. 20, 2012

(54) Interactive Ticker

(76) Inventor: Michael Ryan Weber, San Francisco, CA (US)

(21) Appl. No.: 13/523,682

(22) Filed: Jun. 14, 2012

Related U.S. Application Data
(60) Provisional application No. 61/497,427, filed on Jun. 15, 2011.
(60) Provisional application No. 61/564,516, filed on Nov. 29, 2011.

(51) Int. Cl. H04H 60/35

(52) U.S. Cl. 725/37

(57) ABSTRACT

Methods, apparatuses, graphical user interfaces and computer readable mediums are described for a ticker. The present invention describes, among other things, various ways of processing and displaying data in the ticker, interacting with the ticker, altering characteristics of the ticker and preparing and transmitting data to the ticker.

### CROSS-REFERENCE TO RELATED APPLICATIONS

The present application claims the benefit and priority under 35 U.S.C. 119(e) of U.S. Provisional Application No. 61/497,427, filed Jun. 15, 2011, the entire contents of which are incorporated herein by reference for all purposes. The present application also claims the benefit and priority under 35 U.S.C. 119(e) of U.S. Provisional Application No. 61/564,516, filed Nov. 29, 2011, the entire contents of which are incorporated herein by reference for all purposes.

### BACKGROUND

A. Technical Field

The present invention pertains generally to computer applications, and relates more particularly to an interactive ticker.

B. Background of the Invention

As the line between the Internet and broadcast television continues to blur, the demand for interactive television will continue to grown. Products, such as Apple TV and Google TV currently provide platforms for displaying video streamed from the Internet directly to the user's television. Some televisions even have these services built directly into the device.

In the future, it is expected that these platforms and others will include development environments that developers can use to build applications for the television. This will likely lead to increased demand for interactive features on the television.

One feature currently used with various television programs, such as news programs, sports programs and financial programs, are tickers that dynamically display information to a user. One problem with current tickers is that they are not interactive. Additionally, the information displayed to the user is static and not customized to the user. As a result, most of the information streamed in the ticker is likely not of interest to the user. Thus, the user must constantly monitor the ticker to look for the information that may be relevant to the user.

Another problem with tickers is that they are part of the video stream for a particular program. For example, a ticker of financial information is only available to a user when the user is viewing the associated financial channel. This is because the ticker is part of the video feed for that particular channel being streamed to the user over cable, satellite, etc.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

Various logos and trademarks have been used in the figures of the application that belong to its respective entities. To the best of applicant's knowledge, the owners of the various trademarks are as follows. Twitter and its logo are trademarks of Twitter, Inc. CNN and its logo are trademarks of Cable News Network. “Project Runway” is a trademark of Fashion Cents, LLC. ESPN and its logo are trademarks of ESPN, Inc.

FIG. 1A is a diagram of a display 120 comprising an interactive ticker 110 according to embodiments of the invention.

FIG. 1B is a diagram of a display 120 comprising an interactive ticker 110 according to embodiments of the invention.

FIG. 1C is a diagram of a display 120 comprising an interactive ticker 110 according to embodiments of the invention.

FIG. 1D is a diagram of a display 120 comprising an interactive ticker 110 according to embodiments of the invention.

FIG. 1E is a diagram of a display 120 comprising an interactive ticker 110 according to embodiments of the invention.

FIG. 1F is a diagram of a display 120 comprising an interactive ticker 110 according to embodiments of the invention.

FIG. 1G is a diagram of a display 120 comprising an interactive ticker 110 according to embodiments of the invention.

FIG. 1H is a diagram of a display 120 comprising an interactive ticker 110 according to embodiments of the invention.

FIG. 1I is a diagram of a display 120 comprising an interactive ticker 110 according to embodiments of the invention.

FIG. 1J is a diagram of a display 120 comprising an interactive ticker 110 according to embodiments of the invention.

FIG. 2 is a block diagram of an environment for an interactive ticker 110 according to embodiments of the invention.

FIG. 3 is a block diagram of a method 300 for performing an action in response to a user selection of an interactive element according to embodiments of the invention.

FIG. 4 is a block diagram of a method 400 for changing a video feed displayed on a display device in response to a user selection of an interactive element in a ticker according to embodiments of the invention.

FIG. 5 is a block diagram of a method 500 for generating elements (interactive and/or non-interactive) for display in a ticker according to embodiments of the invention.

FIG. 6A is a diagram of a display 120 comprising an interactive ticker 110 according to embodiments of the invention.

FIG. 6B is a diagram of a display 120 comprising an interactive ticker 110 according to embodiments of the invention.

FIG. 7 is a block diagram of a method 700 for changing a feed in a ticker application according to embodiments of the invention.

FIG. 8 is a block diagram of a method 800 for responding to a request from a ticker application for a data feed to display in the ticker application according to embodiments of the invention.

FIG. 9 is a block diagram of a method 900 for responding to a request from a ticker application for a data feed to display in the ticker application according to embodiments of the invention.

FIG. 10 is a block diagram of a method 1000 for displaying a feed in a ticker application according to embodiments of the invention.

FIG. 11 is a block diagram of a method 1100 for switching a feed in a ticker application according to embodiments of the invention.

### DETAILED DESCRIPTION

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or combinations thereof. Accordingly, the figures described herein are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

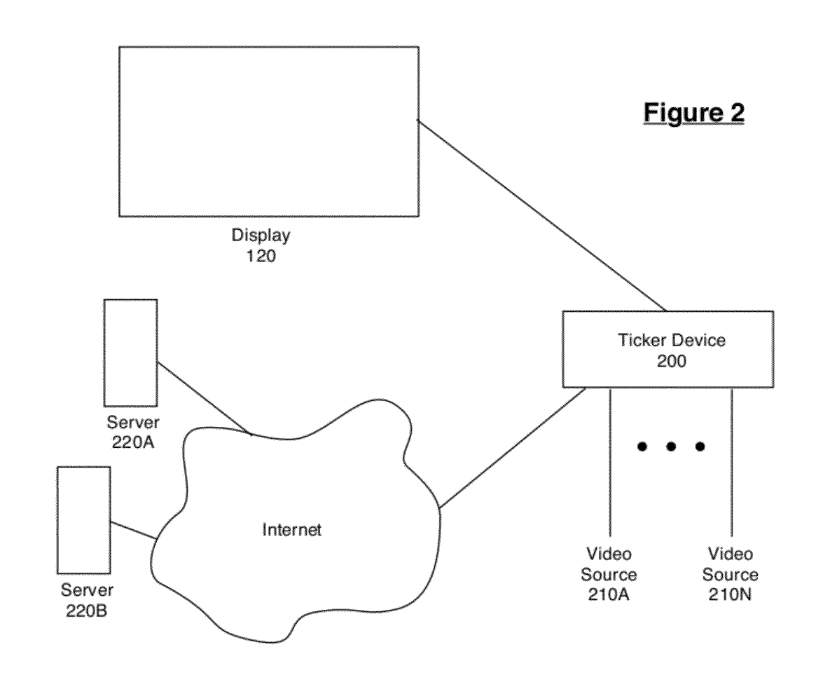

FIG. 2 is a block diagram of an environment for an interactive ticker according to embodiments of the invention. In embodiments, the interactive ticker is a software application implemented on a computing device, labeled ticker device 200, that is capable of receiving data streamed over a network connection, such as the Internet, and displaying the data in an interactive ticker on a display 120. In embodiments, ticker device 200 is a general-purpose computer that executes computer instructions as is well known in the art. In embodiments, ticker device 200 may be a set-top box coupled to a television, such as an Apple TV device, a Google TV device, a cable set-top box, a TIVO set-top box, Boxee set-top box, etc. Further, while ticker device 200 and display 120 are displayed as separate elements in FIG. 2, ticker device 200 and display 120 may be part of the same device. For example, ticker device 200 could be implemented in a laptop computer, smartphone or tablet with an integrated display. As another example, ticker device 200 may be implemented as part of a television.

In embodiments, as shown in FIG. 2, ticker device 200 may be coupled to one or more video sources 210, the Internet and a display 120. In embodiments, ticker device 200 receives a video feed from one or more of the video sources 210 and simultaneously displays the interactive ticker and the video on display 120. Examples of video sources that may provide a video feed to ticker device 200 include, but are not limited to, a cable television feed delivered by coaxial cable, a satellite television feed (e.g. from Directv, Dish Network, etc.), a computer (including mobile devices, such as smartphones and tablets), a digital video recorder (DVR), or a video feed streamed over the Internet (e.g. video from a content provider located on the Internet, such as Hulu, Youtube, etc.).

In embodiments, ticker device 200 is coupled to receive a stream of data for display in the interactive ticker from one or more servers 220 over a network, such as the Internet. For example, ticker device 200 may receive sports scores and news from a sports content server, stock quotes from a financial content server and/or social media data from content servers located on the Internet. In embodiments, ticker device 200 may also receive any additional content that may be streamed over the Internet, including HTML web pages, video, music, etc.

In embodiments, ticker device 200 combines a video from one or more video sources with an interactive ticker and displays the video and the interactive ticker on display 120 as discussed further herein. In embodiments, the interactive ticker is overlaid on a video that is simultaneously displayed on display 120 as discussed further herein. However, it should be noted that the interactive ticker of the present invention is not limited to being overlaid on a displayed video. For example, in embodiments, the interactive ticker may simply be displayed below the video on display 120. In embodiments, the interactive ticker may be displayed in conjunction with a web browser that displays web pages or other information requested over the Internet. In addition, interactive ticker may be displayed in conjunction with static images, such as photos, or simply a blank screen.

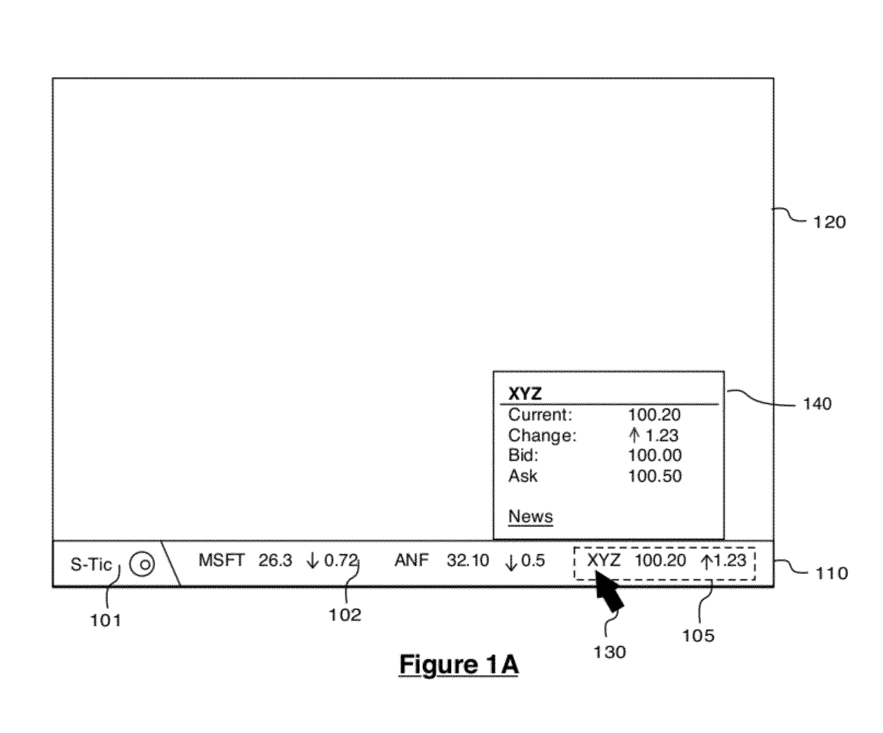

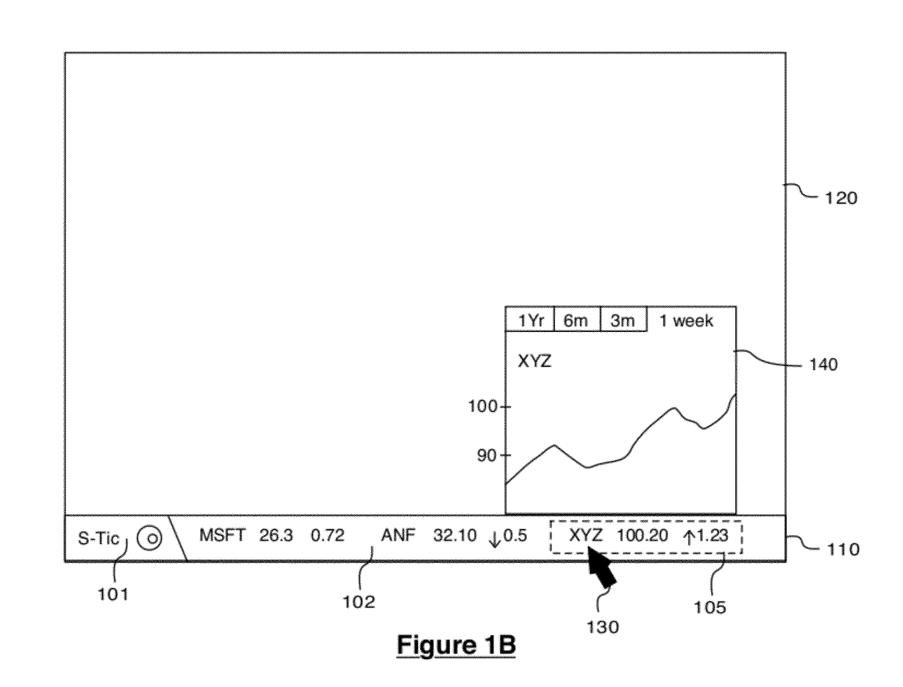

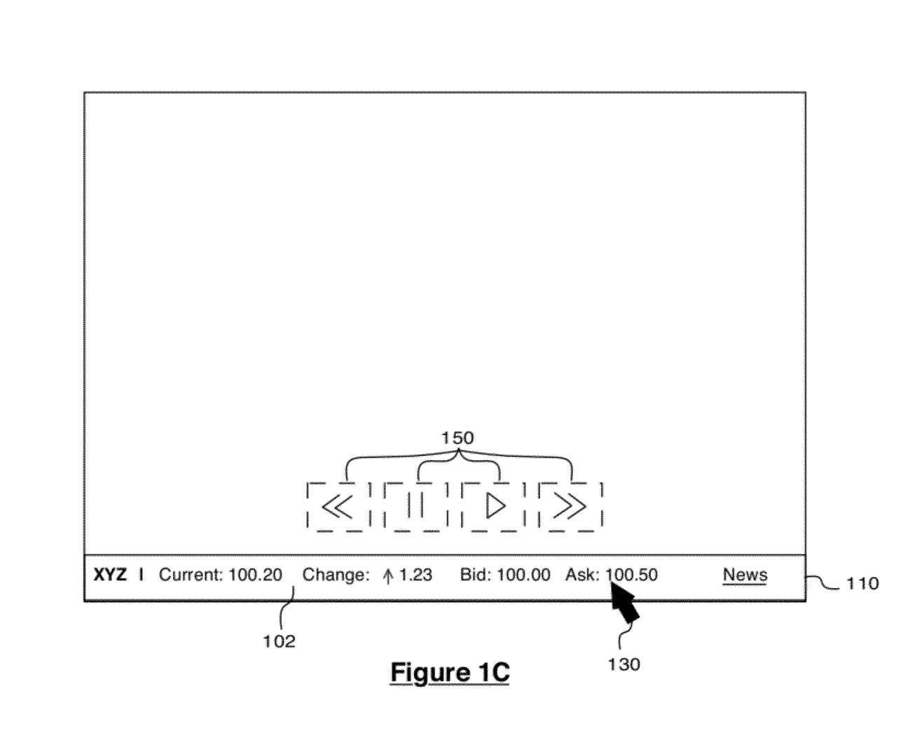

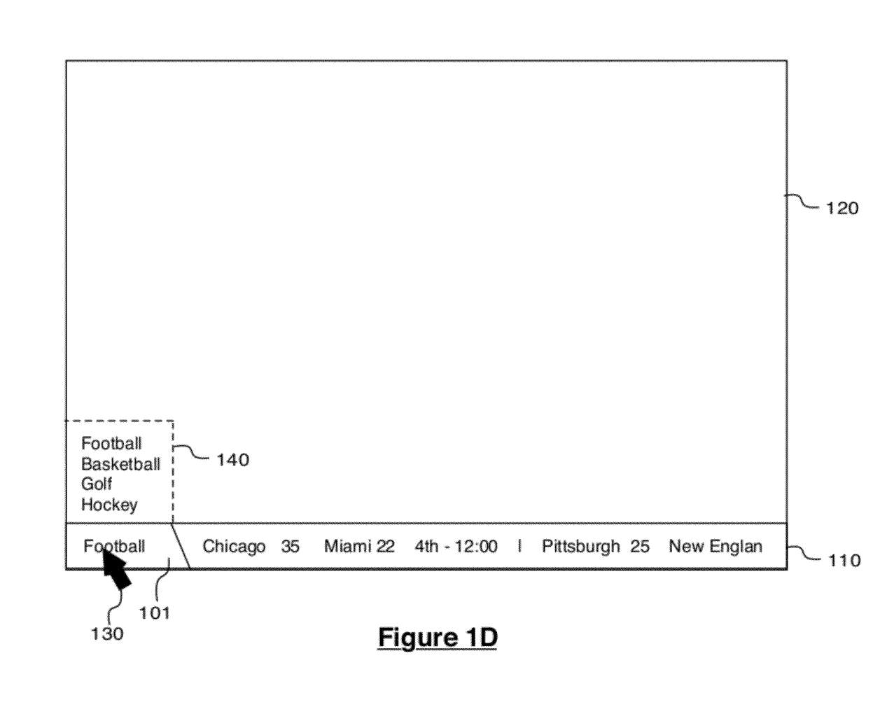

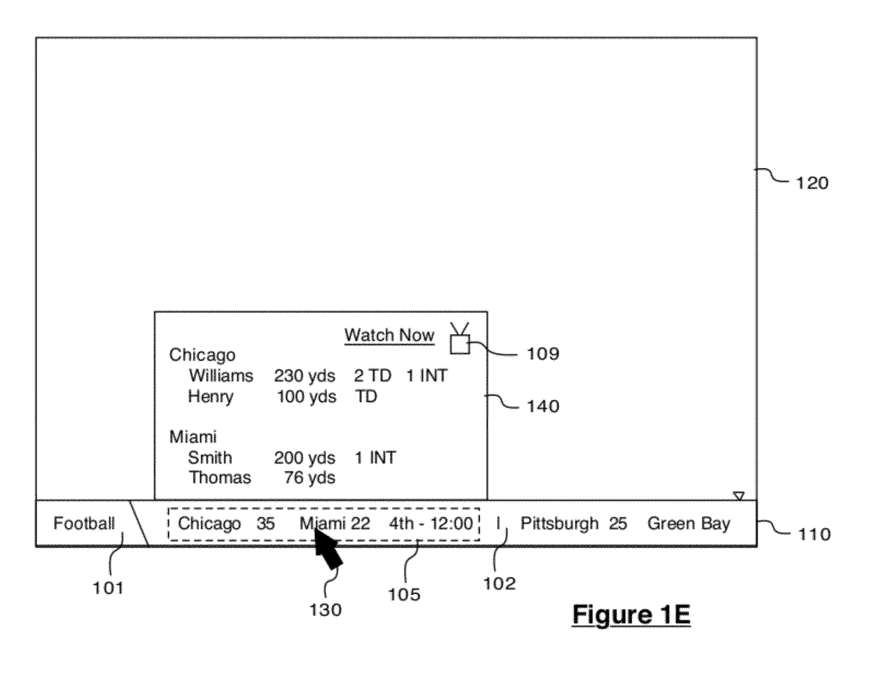

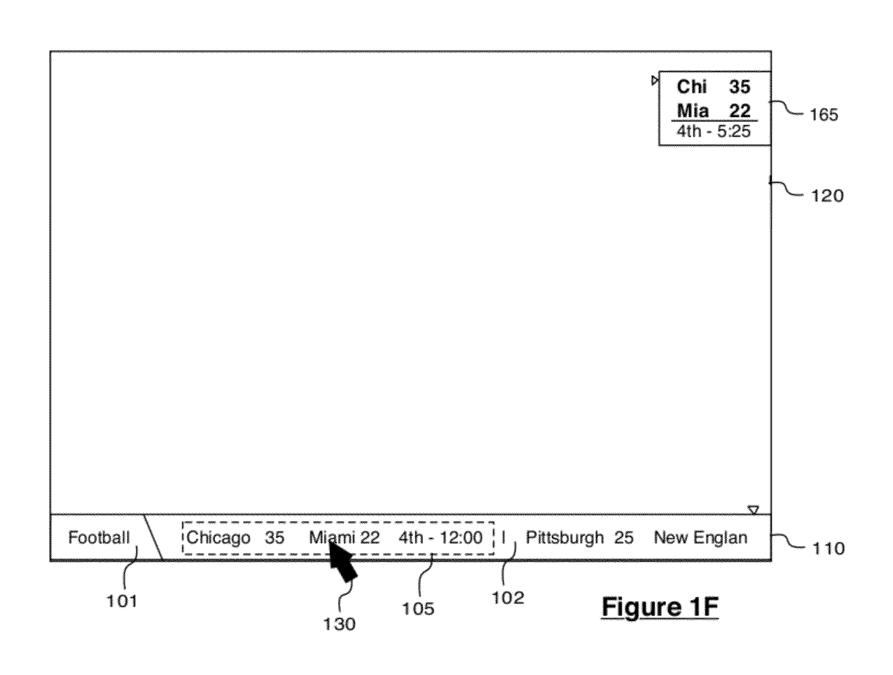

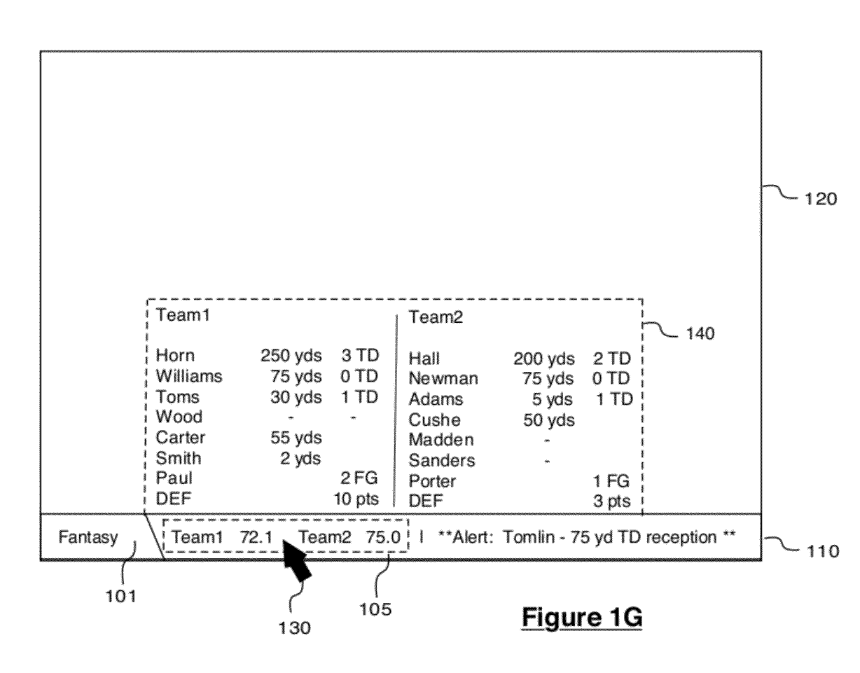

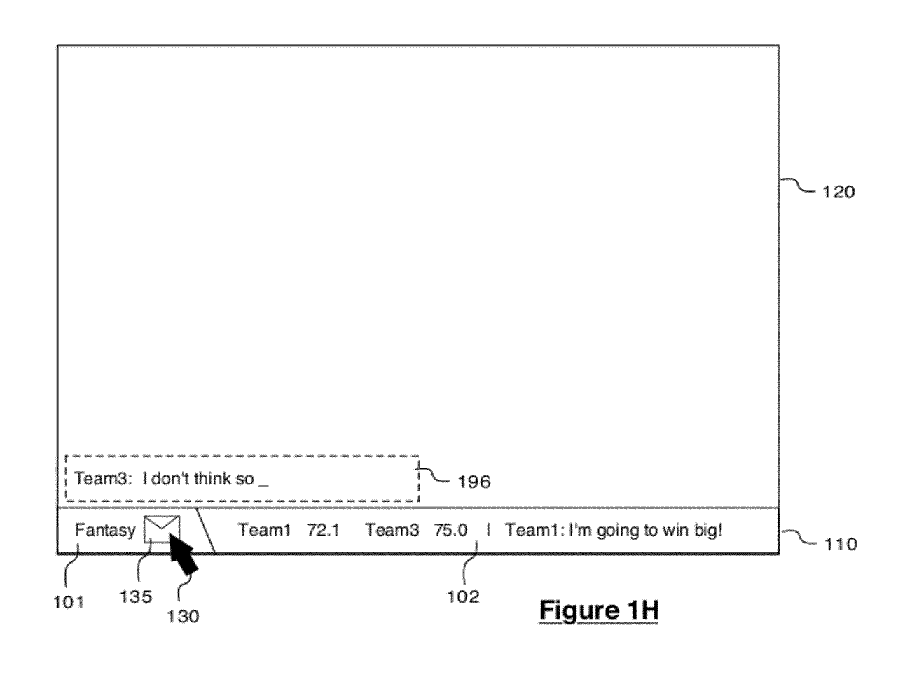

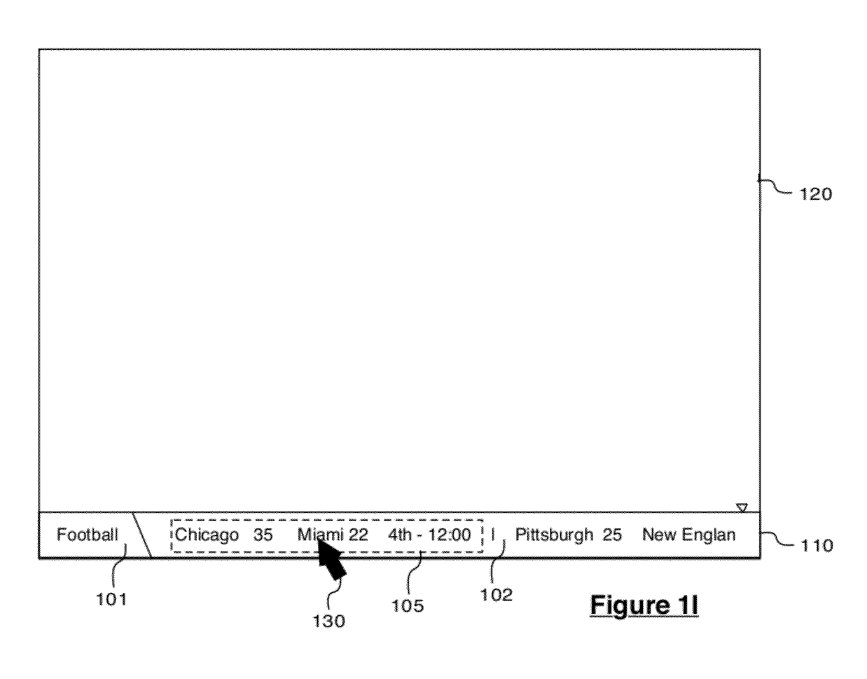

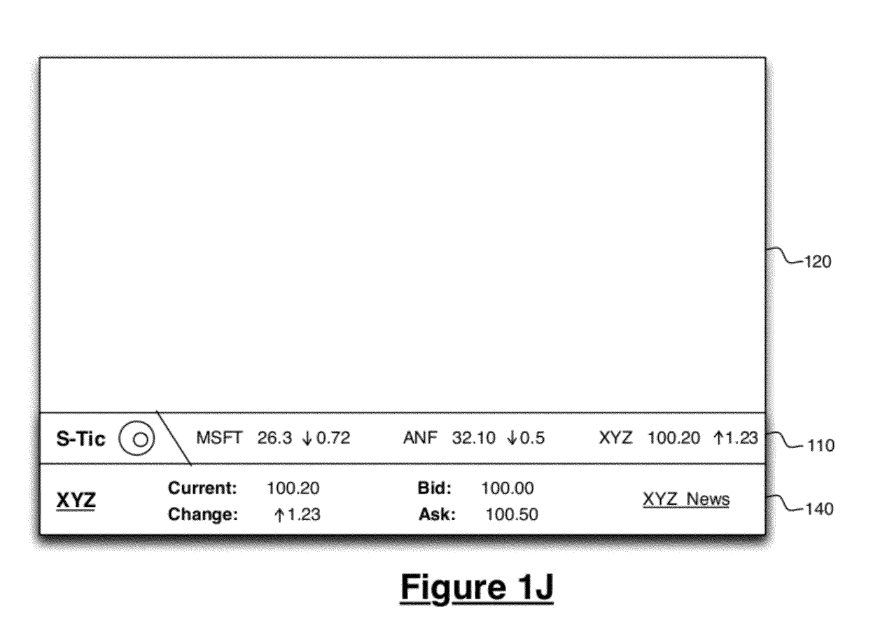

FIG. 1A is a diagram of a display 120 comprising an interactive ticker 110 according to embodiment of the invention. In embodiments, display 120 displays a video (not shown) associated with one or more input video sources in the remainder of the display 120 not taken up by interactive ticker 110. In embodiments, ticker 110 is comprised of a static field 101 and a dynamic field 102. In embodiments, static field 101 displays information that remains constant for a stream of data, such as the source of the information being streamed and displayed in ticker 110. For example, in FIG. 1A, static field 101 displays the name, S-Tic, of the source of the stream of data along with an icon associated with S-Tic. In embodiments, dynamic field 102 dynamically displays (e.g. as scrolling information) data streamed from one or more external sources. In embodiments, the stream of data may comprise interactive and non-interactive elements that are displayed in dynamic field 102.

In the example ticker of FIG. 1A, ticker 110 displays financial data, such as stock quotes, news headlines, etc. In embodiments, the financial data feed is continuously streamed to the ticker device from a server located on a network, such as the Internet, and is presented to the user within ticker 110 as is well known in the art. In embodiments, the information displayed in stock ticker 110 (e.g. the stock quotes) is scrolled across the dynamic field 102 of ticker 110. However, the invention is not limited to scrolling. Other methods for dynamically displaying information in ticker 110 are also supported by the present invention. For example, the information may simply be updated periodically within dynamic field 102.

In embodiments, interactive ticker 110 is overlaid on the bottom portion of a video, such as a television show or movie that is displayed on a display screen 120. However, one skilled in the art will recognize that ticker 110 may be positioned on other portions of display 120. For example, the ticker 110 may be positioned at the top of the display or on the left or right hand side of the display 120. In embodiments, the user may customize the position of the ticker 110 on the display 120. As discussed previously, in embodiments, the ticker 110 may be displayed below a video. For example, the ticker application may control the entire screen and display ticker 110 at the bottom of the screen and display a video, web browser or other application in the remainder of the display 120.

In embodiments, the data displayed in the interactive ticker 110 is received independently of the video feed associated with the video displayed on screen 120. In other words, the video feed may be received from a different source than the streamed data that is displayed in the interactive ticker 110. This is in contrast to the current tickers that are composited at the source of the video content and streamed as part of the video feed that is displayed on the user's television. Thus, the present invention allows for the display of information in ticker 110 that is independent of the video being displayed to the user. For example, a user may choose a sports ticker to display updated sports scores, news, etc. while watching a movie or other non-sports related video. As another example, the user may choose a financial ticker to display stock quotes, etc. while viewing a sporting event, movie, etc.

In embodiments, a user can interact with ticker 110 using a cursor 130, as shown in FIG. 1A. In embodiments, the user can select an interactive element, such as the region 105 surrounding stock symbol XYZ, associated with the data being displayed in ticker 110 to display additional information. Other examples of interactive elements associated with the display data may comprise links or icons that can be selected to display additional information. For example, in embodiments, a temporary window 140 may be displayed above ticker 110 in response to a user clicking on the interactive element associated with the stock symbol XYZ. In this example, window 140 displays the current stock price, the change in price from the previous day's close, the current bid price, the current ask price and includes a link to news items related to the selected stock symbol XYZ. In another example shown in FIG. 1B, window 140 shows an interactive graph of the price action of a stock over time. In embodiments, as shown in FIG. 1C, the additional information may be temporarily displayed in ticker 110 rather than a temporary pop-up window 140. In embodiments, temporary window 140 may be displayed below ticker 110 as shown in FIG. 1J. In this example, ticker 110 may be scrolled upwards on the screen revealing temporary window 140 beneath with the additional information.

In embodiments, an interactive element that is displayed in ticker 110 may comprise a first portion and a second portion. In embodiments, the first portion is the initial information displayed in ticker 110. For example, in FIG. 1A, the first portion comprises the stock symbol XYZ, the current stock price, 100.20 and the daily change, up 1.23. In embodiments, the second portion comprises the additional information that may be displayed to the user when the user selects the interactive element. For example, in the embodiment of FIG. 1A, the second portion comprises the Bid data, the Ask data and the News link (e.g. an HTML URL) that is displayed in window 140 in response to a user selection of the interactive element (e.g. XYZ).

In embodiments, the second portion may comprise a universal resource identifier (URI), such as a universal resource locator (URL), that points to the location of the additional information. In embodiments, when the user selects an interactive element within ticker 110, the additional information associated with the interactive element is requested over a network connection, such as the Internet. For example, responsive to a user selection of an interactive element that comprises a URL, a request for the additional information may be requested from the source associated with the URL. When the additional information is received, it is displayed to the user (e.g. through temporary window 140, ticker 110, etc.). In an alternate embodiment, a web browser or other application appropriate for displaying the additional information received over the Internet may be opened to display the received information. As discussed further herein, in embodiments, the second portion may identify a television channel or other video source to which the ticker application may switch in response to the user selection of the interactive element.

In embodiments, the user can pause the scrolling of (or other method of sequentially displaying) the data in ticker 110 by simply placing a cursor over ticker 110. This allows the user more time to review the displayed information at a given point in time. It also makes it easier for the user to select an interactive element of interest. In embodiments, the information displayed in ticker 110 may be buffered so that the user can pause, rewind and fast forward the data displayed in ticker 110. For example, the information of interest to a user may scroll through ticker 110 before the user has the opportunity to select an interactive element. In such cases, the user can simply rewind the data to review the information of interest and/or select an interactive element within the ticker feed. In one embodiment, well known play mode symbols may be included on ticker 110 or displayed temporarily above ticker 110 based on a user action, such as placing a cursor over ticker 110. For example, FIG. 1C shows well known pause, play, fast forward and rewind buttons 150 above ticker 110 overlaid on the video displayed on screen 120 that the user may use to control the display of data within ticker 110. As another example, the user may use the pause, play, rewind and/or fast forward buttons on a remote control to control the display of data within ticker 110.

In embodiments, selecting an interactive element causes a dedicated widget to be displayed on the display, which regularly updates the information associated with the selected interactive element. In embodiments, the second portion of the interactive element may comprise a command or widget identifier, which causes the interactive ticker application to launch the associated widget. For example, in FIG. 1F, a sports widget 165 is overlaid on the video displayed on display 120 in response to a user selection of the interactive element 105 associated with a football game that is currently in progress. In this example, the sports widget 165 may continuously update the score, period, time remaining, etc. for the game in progress. Similarly, a financial widget may be launched in response to the user selecting an interactive element associated with a stock, as discussed above with respect to FIG. 1A. The financial widget may continuously update the stock price, etc. of the stock during market hours. In embodiments, the widget may continuously update the information by receiving and displaying updated information received over the Internet, etc.

In embodiments, the user may customize the data feed streamed to and/or displayed in ticker 110. For example, FIG. 1D shows a ticker 110 that displays sports scores, news, etc. according to embodiments of the invention. As shown in FIG. 1D, ticker 110 is displaying football scores. In response to a user selection (e.g. clicking) of the static field 101 with a cursor 130, a pop-up window 140 may be displayed to the user listing feed identifiers for a plurality of sports feeds. When the user selects a particular feed identifier from the list, e.g. Basketball, ticker 110 will request the basketball related feed from the appropriate source and display the received basketball information to the user in the interactive ticker 110.

In embodiments, ticker 110 may rotate the stream of information for the various sports in a particular order, e.g. the order listed in window 140 (e.g., Football followed by Basketball, then Golf, then Hockey, and then back to Football) of FIG. 1D. In this embodiment, in response to a user selection of a feed identifier for a particular sport from window 140 of FIG. 1D, the stream will jump immediately to displaying scores and news items related to that sport. For example, if the user selects Golf when ticker 110 is displaying Football scores, etc., ticker 110 may immediately skip to displaying Golf scores and then return to the rotation display (e.g. followed by Hockey information, then Football, etc.).

In embodiments, the user may further customize a feed by limiting the types of information to display in ticker 110 for a particular feed. For example, a user may want to limit a sports ticker's feed to scores and news related to specific sports or to particular teams. In this embodiment, the stream may be customized for the particular user and scores and news from other sports, teams, etc. would be excluded from the stream to the user. As another example, a financial-related ticker 110 could be limited to specific stocks of interest to the user. Similarly, the user could limit the types of headlines (e.g. business news, sports, local news, politics, etc.) displayed to the user in ticker 110.

In embodiments, ticker 110 may be configured by a user to display information received from multiple source feeds. For example, the user may wish to view financial information and sports information within ticker 110. In one embodiment, data streamed from the two sources may be combined into a single feed that is displayed in ticker 110. In embodiments, the various feeds displayed to the user in ticker 110 may be rotated as discussed above. For example, the financial data may be displayed for a predetermined period of time, followed by a display of the sports data for a predetermined period of time, followed by the financial data, etc.

FIG. 1G is a diagram of an interactive fantasy sports ticker 110 according to embodiments of the present invention that displays scores and statistics relevant to a user's fantasy sports team/league. In embodiments, the user can interact with fantasy sports ticker 110 by selecting an interactive element as discussed previously. For example, the user may use a cursor 130 to select a matchup of various teams as they scroll across the screen. In one embodiment, the interactive element comprises a first portion and a second portion as discussed previously. In this example, the first portion of interactive element 105 comprises the scores for both teams (i.e., Team1 and Team2). The second portion includes the statistics for the players that make up Team1 and Team2. As shown, when the user selects interactive element 105, the second portion may be displayed to the user in window 140.

FIG. 1H is a diagram of an interactive ticker 110 that incorporates a text field that allows the user to input text for an application, such as Twitter, Facebook or chat, according to embodiments of the invention. In the example of FIG. 1H, chat messages from the owners of the various teams that make up a fantasy league can be displayed in interactive ticker 110 in addition to scores and stats relevant to the league. In embodiments, a message icon 135 is included in the static field 101. When the message icon is selected by the user, a temporary text field 196 is displayed to the user as shown in FIG. 1H. In one embodiment, the user enters a message into text field 196 that is then streamed to the other owners of the league and/or posted to the user's status field within a web page associated with the league as is well known in the art. In embodiments, the system may also be configured to link with a user's mobile text messaging account or email to send the message to the other participants in the fantasy league, etc. In an alternative embodiment, all or a portion of ticker 110 may be turned into a temporary text field 196 in response to a user selection of the message icon. In yet another embodiment, the text field 196 is included in the static field 101.

In embodiments, interactive ticker 110 may receive information relevant to a user's account, such as an email account, Twitter account, Facebook account, etc. For example, interactive element 110 may receive a feed of messages, referred to as “tweets,” from other Twitter subscribers that are followed by the user in the user's Twitter account. In embodiments, these tweets may be displayed in the interactive ticker in a scrolling fashion as described previously. In embodiments, a text field 196 may be provided to the user in which the user can input tweets and post them to the user's account for display to the various followers of the user. This allows the user to tweet about a show or other video being displayed on display 120 without having to access a different device (such as a laptop or mobile device) or even a separate screen. The user can send and receive tweets while enjoying the video or other content displayed in display 120. One skilled in the art will recognize that these embodiments are not limited to Twitter accounts and will work for a number of different user accounts, including Facebook, email, etc.

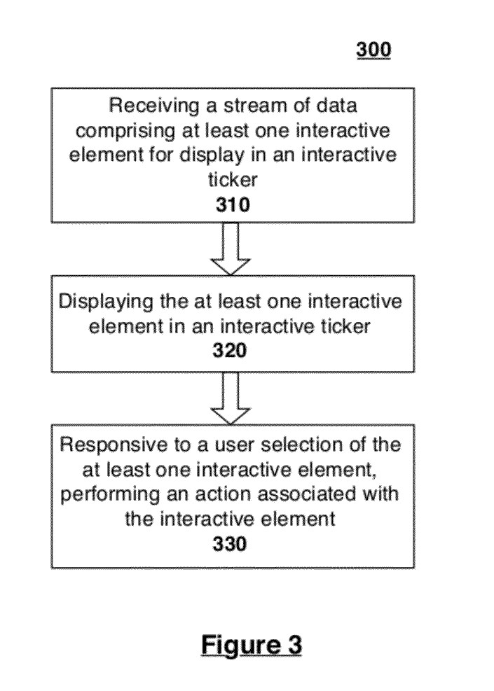

FIG. 3 is a block diagram of a method 300 for performing an action in response to a user selection of an interactive element according to embodiments of the invention. In embodiments, the method 300 is implemented by a software application on a general-purpose computer. For example, the method 300 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a stream of data is received 310 comprising at least one interactive element for display in an interactive ticker on a display screen (e.g. a television) as discussed previously. In embodiments, the data may comprise a stream of data received over a network, such as the Internet, from a server. In embodiments, the data may comprise interactive elements and non-interactive elements that are displayed in the interactive ticker.

In embodiments, the interactive elements may comprise a first portion and a second portion. In embodiments, the first portion comprises data to be displayed initially to a user in the interactive ticker. In embodiments, the second portion comprises additional information that is accessed and/or processed in response to a user selection of the interactive element as discussed previously. In embodiments, the second portion comprises additional data that is displayed on the display screen in response to a user selection of the interactive element. In embodiments, the second portion may comprise a command that is executed in response to a user selection of an interactive element. For example, the second portion may comprise a command to change the video feed (e.g. the channel) being displayed on the display screen. In embodiments, the second portion may comprise a reference to a channel of a broadcast source feed. In embodiments, the second portion comprises a universal resource identifier (URI), such as a universal resource locator (URL), that identifies a location (e.g. an internet address) of additional information to display or process in response to the user selection of the interactive element.

In embodiments, the at least one interactive element is displayed 320 in the interactive ticker. In embodiments, the received stream of data is formatted and sequentially displayed in the interactive ticker in a scrolling fashion. In embodiments, the stream of data may comprise interactive elements and/or non-interactive elements.

In embodiments, an action associated with the interactive element is performed 330 in response to a user selection of the at least one interactive element within the interactive ticker. For example, in embodiments, if the second portion of the interactive element comprises additional information to display, the additional information is displayed in a temporary window. In embodiments, if the second portion comprises a command, the command is executed by the device. For example, if the second portion comprises a command to change the video feed (e.g. change the channel), the device causes the channel to change as discussed further herein. In embodiments, if the second portion comprises a reference to a channel of a broadcast source feed, the application may perform an action to change the source feed displayed on a display to the referenced channel. In embodiments, if the second portion comprises a URI, the device causes the information to be requested from the location associated with the URI. For example, if the URI comprises a URL, the device may instantiate a browser application, which requests the information from the location associated with the URL and displays the received content on the display screen.

FIG. 1I is a user interface for switching a video feed in response to the selection of an interactive element according to embodiments of the invention. In embodiments, the interactive ticker application causes the device to switch the current video feed shown in a display to a video feed associated with a selected interactive element in ticker 110. In the example of FIG. 1I, interactive element 105 is associated with a football game between Chicago and Miami. In response to the user selection of interactive element 105, the application may issue a command to switch the video feed displayed on display 120 to the video feed associated with the game as discussed further herein. In embodiments, a special link, television icon or other identifier may be included in interactive element 105 to provide an indication to the user that video content associated with the interactive element 105 can be accessed by selecting (e.g. clicking) the interactive element 105. In embodiments, the television icon or other identifier may comprise a button on a remote control that the user may press to cause the ticker to switch the video feed displayed on display 120.

In embodiments, the interactive ticker application of the present invention is implemented in a device (e.g. set-top box, television, computer, etc.) that is capable of aggregating and/or controlling content from a variety of video sources. For example, the invention may be implemented as an application on a GoogleTV set-top box that is capable of receiving a video feed from a broadcast television provider (e.g. Comcast, Xfinity, Time Warner, Dish Network, Directv, etc.), and content (e.g. web pages, video, etc.) from the Internet. The user interface of GoogleTV provides an interface to allow users to view Internet content (video and web pages) and/or a video feed from the broadcast provider.

In embodiments, selecting an interactive element within the interactive ticker initiates an application programming interface (API) call that instructs the device (such as GoogleTV, AppleTV, Tivo, cable box, etc.) to change the video feed as discussed further herein. For example, if a live video feed for a channel reference in a selected interactive element is available via the user's cable or satellite broadcast subscription, the application may initiate an API call to channel change so that the video feed associated with the channel is displayed to the user.

For example, at the 2011 Google I/O Developer Conference, Google announced that in the summer of 2011, Google will provide developers with access to the television channels available to each particular user along with a universal resource identifier (URI) for each channel that can be used to tune to a particular channel. Since the broadcast provider varies between users, during setup of GoogleTV device, the user indicates the broadcast television provider (e.g. Directs, Comcast, Dish Network, Time Warner, etc.) that provides their television service. Based on this information, the device (in this case GoogleTV) knows the channel listings available to the user and is capable of controlling the video feed by making the appropriate API call with the URI corresponding to a particular channel.

In embodiments, the interactive ticker of the present invention leverages the broadcast channel information stored in the device to perform various commands, such as changing the channel of the broadcast video feed. In embodiments, the source providing a stream of data to the interactive ticker may provide a generic reference to a broadcast channel in an interactive element. For example, an interactive element displayed in a ticker may comprise a generic reference to a broadcast channel. An example of a generic reference is the name of the channel, e.g. the Entertainment Sports Programming Network (ESPN), Discovery Channel, CNBC, etc. In response to a user selection of the interactive element, the application determines the channel associated with the generic reference for the user's broadcast provider and initiates a command to change the broadcast source feed to the appropriate channel, as discussed further herein.

In embodiments, this allows the source of a stream of data to be displayed in the interactive ticker to transmit the same feed to various users, regardless of their broadcast providers. The application/device determines the appropriate channel based on the channel listing for each user's broadcast provider and performs the appropriate action to change the video feed to that channel. As a result, the source of the stream of data does not have to customize the feed for each user based on the user's broadcast provider.

For example, a sports ticker may display an interactive element providing information regarding an in-progress sporting event that the user can select to switch from the current video feed being shown on the display to the video feed associated with the game. Thus, if the game is being televised on the ESPN channel, the interactive element may include a reference to ESPN, as discussed further herein. Based on this information, the device software can look up the appropriate URI for ESPN based on the channels available to the user and perform an API call to cause the system to change the channel of the video feed to the channel associated with ESPN.

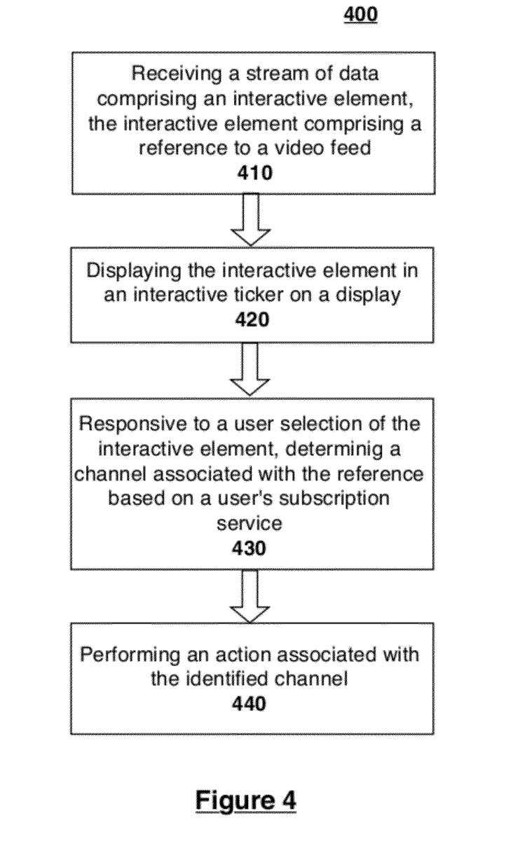

FIG. 4 is a block diagram of a method 400 for changing a video feed displayed on a display device in response to a user selection of an interactive element in a ticker according to embodiments of the invention. In embodiments, the method 400 is implemented by a software application implemented on a general-purpose computer. For example, the method 400 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a stream of data is received 410 comprising an interactive element comprising a reference to a video feed. In embodiments, the data may comprise a stream of data received over a network, such as the Internet, from a server, as discussed previously. In embodiments, the data may comprise interactive elements and non-interactive elements that are displayed in the interactive ticker.

In embodiments, an interactive element may comprise a first portion and a second portion as discussed previously. The first portion comprises data to be displayed in the interactive ticker. For example, the first portion may comprise the current score of a game, the period of the game and the time remaining as shown in FIG. 1I. In embodiments, the second portion may comprise a reference to a video feed. Example references include the name associated with a broadcast television channel (e.g. ESPN, CNN, etc.), or a URL identifying a location on a network (e.g. Internet) from which a video feed may be accessed. In embodiments, the reference to the video feed may comprise the channel associated with the video feed.

In embodiments, the interactive element is displayed 420 in the interactive ticker as discussed previously. In embodiments, the received stream of data is formatted and sequentially displayed in the interactive ticker in a scrolling fashion. In embodiments, the stream of data may comprise interactive elements and/or non-interactive elements.

In embodiments, in response to a user selection of an interactive element in the interactive ticker, a broadcast channel associated with the video feed reference of the selected interactive element is determined 430 based on a user's subscription service. For example, in a set-top box that aggregates content from different video sources, if the video feed reference of the interactive element is the name of a broadcast channel (e.g. ESPN), the application may compare the name of the broadcast channel with the channel listing associated with the user's broadcast provider to identify the appropriate channel. In embodiments, if the reference comprises the channel, the channel is determined by simply accessing the channel information in the reference.

In embodiments, an action associated with the identified channel is performed 440. For example, in embodiments, the video feed displayed on the display is changed to the video feed associated with the identified channel. For example, the application may initiate a command (e.g. an API call) to the device and/or application that controls the source feed displayed on the display to change the source feed to the video feed associated with the identified channel. As another example, the application may initiate a command to a digital video recorder (DVR) to record the video source of the identified channel. In embodiments, the DVR may record the game or other program associated with the selected interactive element while the user continues to watch the current video feed being shown on the display.

In embodiments, the command to the DVR may instruct the DVR to record a program of interest that will take place in the future. For example, in embodiments, the reference may identify the channel or name of the broadcast channel associated with the video feed and a future time when the video of interest will be broadcast. In embodiments, the application may issue a command to the DVR to record the video feed associated with the identified channel at the specified time.

FIG. 1E is an interactive sports ticker 110 according to embodiments of the present invention that displays sports-related scores, news, etc. In embodiments, the user may interact with sports ticker 110 by selecting an interactive element 105 as discussed previously. For example, the user may use a cursor to select a game as it scrolls across the screen. In one embodiment, the data associated with interactive element 105 comprises a first portion and a second portion as discussed previously. In this example, the first portion comprises the scores for both teams, the period of the game, and the time remaining.

In one embodiment, the second portion includes various statistics related to the game that may be displayed to the user in temporary window 140 in response to a user selection of the interactive element 105, as shown in FIG. 1E. In embodiments, the second portion may also comprise an action identifier, such as a link or an icon, which the user may select within window 140. For example, a link may be selected that launches a web browser to load a web page relevant to the game, statistics, etc. In one embodiment, the action identifier may launch a dedicated widget (e.g. as shown in FIG. 1F) on the display 120 that tracks the progress of the game.

In one embodiment, the action identifier may be selected to switch the video feed being displayed in display 120, as discussed previously. For example, in the example of FIG. 1E, the user can select the “Watch Now” link or the television icon 109 in window 140, to cause the system to switch the source video feed from the current video feed being displayed on display 120 to the source feed associated with the game. In essence, this changes the channel to the channel broadcasting the game, as discussed previously. Similarly, if the game is over, a link or icon may be provided to a highlights video that the user may select to request a video feed of highlights for display on display 120. In one embodiment, if the game takes place in the future, selecting the link or icon may cause a command to be sent to the DVR to record the game in the future or to set a reminder to watch the game.

In the embodiments discussed above, the interactive ticker 110 displays interactive and non-interactive elements received in a stream of data from an external source. However, one skilled in the art will recognize that the invention is not limited to displaying interactive and non-interactive elements received in a stream from an external source. In embodiments, the interactive ticker application of the present invention may generate interactive and non-interactive elements to display in the ticker. For example, the interactive ticker application may access information, such as web pages, Really Simple Syndication (RSS) feeds, spreadsheets, etc., over the Internet and parse the pages to identify information of interest and generate interactive and/or interactive elements to display in the interactive ticker associated with the parsed content.

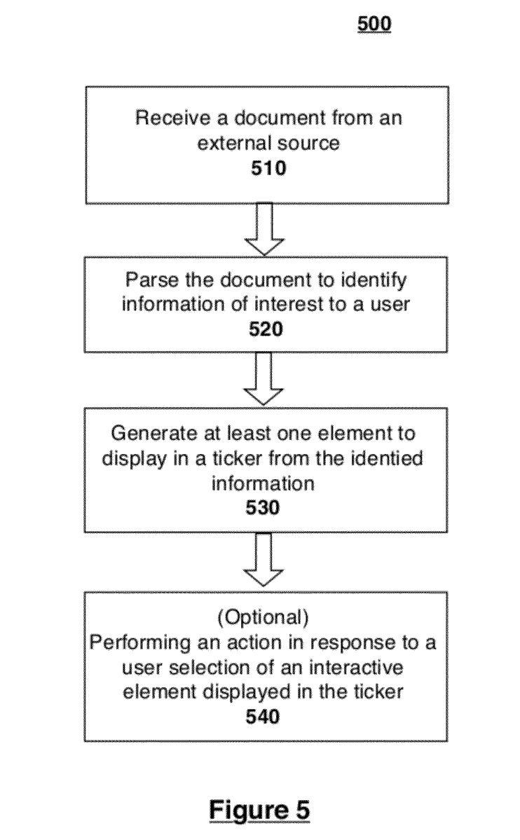

FIG. 5 is a block diagram of a method 500 for generating elements (interactive and/or non-interactive) for display in a ticker according to embodiments of the invention. In embodiments, the method 500 is implemented by a software application on a general-purpose computer. For example, the method 500 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a document is received 510 from an external source. For example, the application may request a document from a server located on a network such as the Internet. The server may respond with a document that comprises information that may be relevant to a user. One skilled in the art will recognize that the invention works with a variety of documents including, but not limited to, web pages, xml documents, RSS feeds, word processing documents, PDF documents, etc. For example, the application might access a web page associated with a user's Twitter account that lists the various tweets from those individuals that are followed by the user.

In embodiments, one or more documents (e.g. web pages) are requested based on the current content being viewed by the user. In embodiments, one or more documents relevant to the current television channel/program and/or subject matter of the program may be requested and received by the application. For example, the ticker application may initiate a search query of Twitter feeds associated with the current sporting event being viewed by the user and receive a web page document comprising various tweets that may be displayed to the user in ticker 110. As another example, during an election night, the ticker application may periodically request one or more web page documents that comprise various election exit polls and/or election results. In embodiments, the ticker application may parse the data from the one or more documents for display to the user.

In embodiments, the document is parsed 520 to identify information of interest to a user. For example, the application may parse the web page associated with the user's Twitter account to extract one or more tweets. It should be noted that invention is in no way limited to the Twitter example described with respect to this embodiment. One skilled in the art will recognize that this embodiment of the invention has much broader applicability.

In embodiments, the application generates 530 at least one element to display in a ticker from the identified information. For example, the application may generate an element comprising a tweet parsed from the web pages associated with the user's account. In embodiments, the element may be an interactive element or a non-interactive element. For example, in embodiments, the tweet may simply be displayed as a non-interactive element in the ticker without any interactive capability. In embodiments, the tweet may be an interactive element. For example, the interactive element may comprise a first portion comprising the text of the tweet and an interactive portion comprising a URL to the web page associated with the user's account. As another example, the first portion may comprise a portion of the tweet (e.g. the first 70 characters of the tweet), while the second portion may comprise the entire tweet (e.g. all 14 characters of the tweet).

In embodiments in which the element is an interactive element, the application performs 540 an action in response to a user selection of the interactive element within the ticker. In the example above in which the second portion comprises a URL to the web page associated with the user's Twitter account, a user selection of the interactive element, may cause the interactive ticker application to launch a web browser application to the web page associated with the URL. In the example in which the first portion comprises the first portion of the tweet and the second portion comprises the entire tweet, a temporary window may be displayed showing the entire tweet in response to a user selection of the interactive element.

One skilled in the art will recognize that the invention has broad applicability beyond that described above. For example, the ticker may be configured to receive streamed data from any source and display that data to a user in a way that the user can interact with the information to obtain additional information.

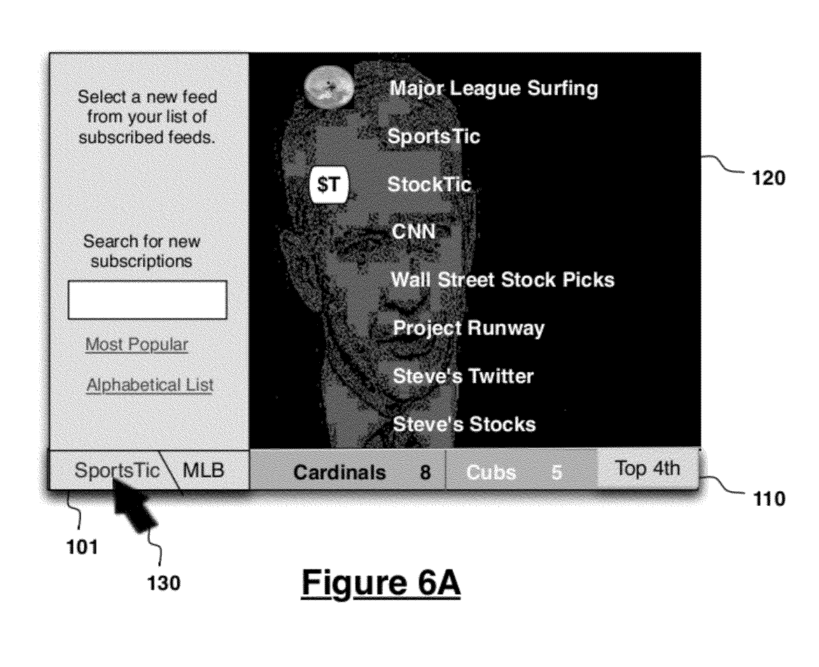

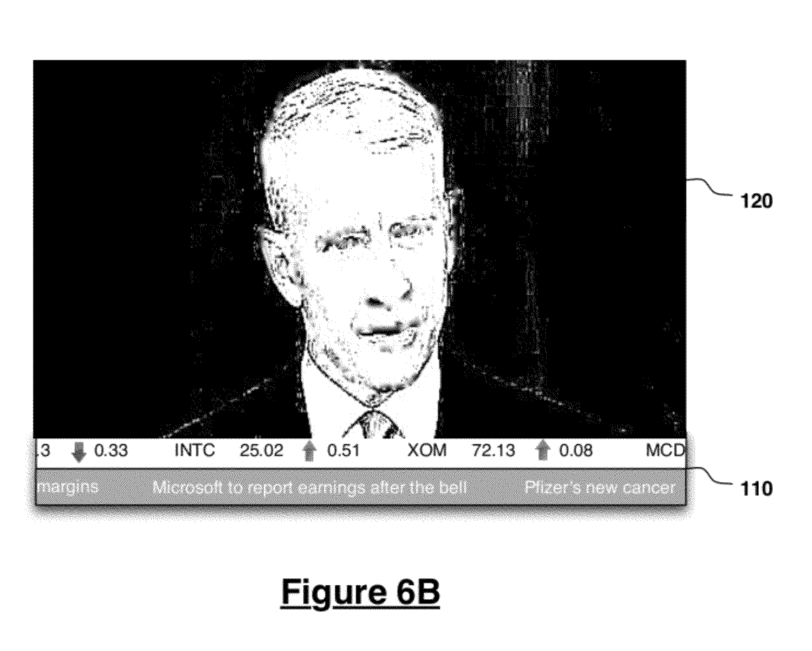

In embodiments, the ticker application of the present invention is a platform that is capable of receiving and displaying data feeds from multiple content providers. For example, FIG. 6A shows a ticker application 110 in which a user may select a feed from a given content provider from a list according to embodiments of the invention. In embodiments, the list of available feeds may be displayed in response to a user action, such as clicking static field 101 within the ticker 110 or pressing a specific button on a remote control. In embodiments, the user may select one of the feeds from the list to initiate a request for the feed data from the content provider for display in ticker 110. For example, if the user selects the StockTic feed from the list, ticker 110 may replace the sports feed, shown in FIG. 6A, with the stock-related feed, as shown in FIG. 6B. As discussed previously, in embodiments, a feed may comprise a stream of data from a content provider that comprises data for display to the user. In other embodiments, as discussed above with respect to FIG. 5, a feed may comprise data parsed from a document (e.g. web page, RSS feed, etc.) downloaded over the Internet.

In embodiments, ticker 110 may alter at least one characteristic of the ticker 110 for the particular feed being displayed. These embodiments allow the ticker 110 to be customized to the “look and feel” associated with the content provider and/or content of the feed. For example, ticker 110 may alter the color scheme, content provider logo, font type, ticker layout, scroll speed and/or other characteristics of the ticker user interface for each content provider and/or feed. As an example, FIG. 6B shows a split-level ticker 110 according to embodiments of the invention that has two rows for displaying ticker information, while FIG. 6A shows a traditional one row ticker 110. In embodiments, the ticker 110 may alter the layout between a one-row ticker and a two-row ticker depending on the content provider and/or feed to be displayed in ticker 110.

In embodiments, one or more characteristics, such as the color scheme, graphics, etc. for a content provider and/or feed may be stored in the memory of the ticker device. However, in some devices, such as television sets, the memory may be limited. Thus, in embodiments, the content providers may include setup information as part of the data stream of the feed that provides and/or identifies one or more characteristics to be altered in the ticker. In embodiments, the setup information may comprise replacement graphics, such as a logo to be displayed in the static field 101 of the ticker and/or data defining one or more characteristics, such as the color scheme, font type/size, ticker dimensions, etc.

In embodiments, the ticker application alters one or more of the characteristics in response to the received information. These embodiments also allow the content provider to alter one or more characteristics of the ticker application at any time during the feed. For example, a content provider of a sports-related feed may want to use a color scheme for basketball-related news that is different from the color scheme used for golf-related scores. In this example, the content provider may include setup information in the feed, before the data comprising the golf scores, indicating the desired color scheme (and/or other characteristics) for the ticker application. In response to receiving the color scheme information, the ticker application may change the color scheme of the ticker user interface prior to displaying the golf scores/news.

In embodiments, ticker application 110 may come pre-installed with one or more feed subscriptions from one or more content providers. In embodiments, the user may subscribe to additional feeds from these or other content providers. In embodiments, the ticker application provides a search interface and/or a listing interface for searching for and selecting additional feeds of interest. In embodiments, newly subscribed feeds are added to the list feeds that may be displayed to the user.

In embodiments, ticker application 110 may store generic information for one or more feeds that is displayed in ticker 110 when the device is not connected to the Internet or other source to receive a feed from a content provider. For example, in embodiments, the ticker application may store an interactive element comprising a content provider's website, a company's tagline or other branding slogans, etc. to display when a communications channel is not available to receive a feed from the content provider. Similarly, the generic information may be displayed when the server or other device hosting the feed is not available to stream the data to the ticker application.

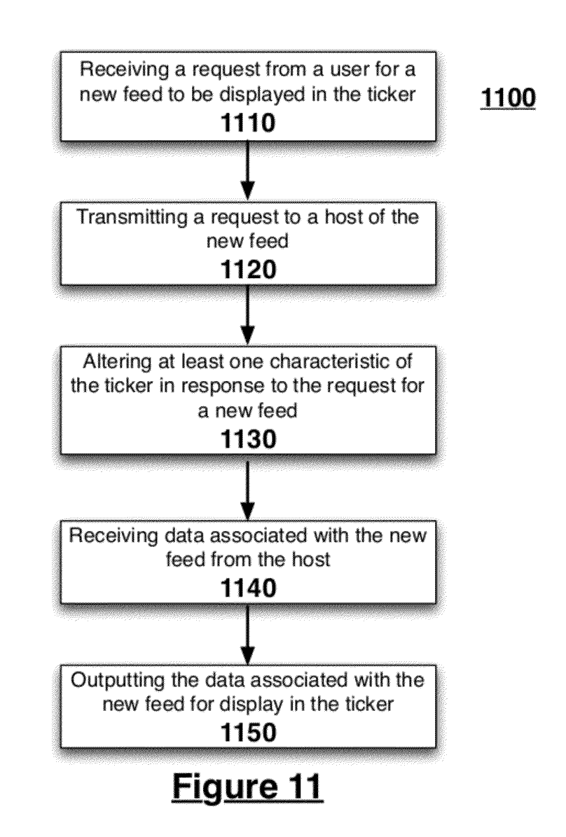

FIG. 7 is a block diagram of a method 700 for changing a feed in a ticker application according to embodiments of the invention. In embodiments, method 700 is implemented by a software application on a general-purpose computer or a ticker device. For example, the method 700 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, the ticker application receives 710 a request from a user for a new feed to be displayed in the ticker application. For example, a list of feeds may be displayed to a user as shown in FIG. 6A in response to a user selection of a static field within the ticker application. One skilled in the art will recognize that there are other user actions that may be used to trigger a display of a list of available feeds to the user, including pressing one or more buttons on a remote control. In embodiments, the user may select (e.g. by clicking) a feed from the list. Responsive to the selection, the ticker receives a request for a new feed for display in the ticker.

In embodiments, the ticker application transmits 720 a request to the host of the new feed. For example, the ticker application may transmit a request over the Internet to a server associated with the new feed.

In embodiments, the ticker application may optionally transmit 730 a termination request to a host associated with the current feed being displayed to the user. For example, if the ticker application is currently displaying a sports-related feed and receives a request for a new feed from the user, the ticker application may transmit a termination request to the host associated with the sports-related feed instructing the host to stop streaming data associated with the sports-related feed to the ticker application.

In embodiments, the ticker application receives 740 data associated with the new feed from the host of the new feed. In embodiments, the new feed is received from a server associated with the new feed that streams data associated with the requested feed to the ticker application. In embodiments, the data may comprise interactive and non-interactive elements for display in the ticker application as discussed previously.

In embodiments, the ticker application outputs 750 the data associated with the new feed for display in the ticker. As discussed previously, there are number of ways in which the data may be displayed within the ticker interface, including a scrolling display of the streamed data. In embodiments, the data may comprise interactive and/or non-interactive elements as discussed previously.

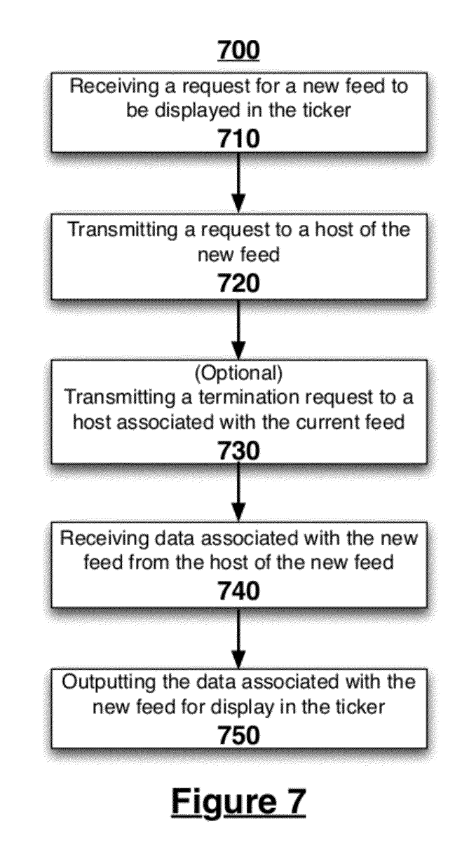

FIG. 8 is a block diagram of a method 800 for responding to a request from a ticker application for a data feed to display in the ticker application. In embodiments, the method 800 is implemented by a software application on a general-purpose computer or a server computer. For example, the method 800 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a content provider receives 810 a request from a ticker application. In embodiments, the request comprises a request for the content provider to stream a data feed to the ticker application for display.

In embodiments, the content provider transmits 820 setup information defining at least one characteristic of the ticker application. As discussed previously, in embodiments, the “look and feel” of the ticker application may be customized for each data feed. In embodiments, the setup information comprises information for altering at least one characteristic of the ticker application. Examples of setup information includes, but is not limited to, a color scheme for the ticker, the font type and/or size for displaying information in the ticker application, the content provider's logo or other graphics, and/or a layout of the ticker (e.g. one row or two rows).

In embodiments, the content provider transmits 830 data for display in the ticker application. As discussed previously, in embodiments, the data comprises a stream of interactive and/or non-interactive elements that may be displayed to the user in the ticker application. In embodiments, the data may comprise an interactive element that comprises a first portion and a second portion as discussed previously. In embodiments in which the ticker layout is divided into two rows, each element (interactive or non-interactive) may comprise a row identifier of the row of the ticker in which the element is to be displayed.

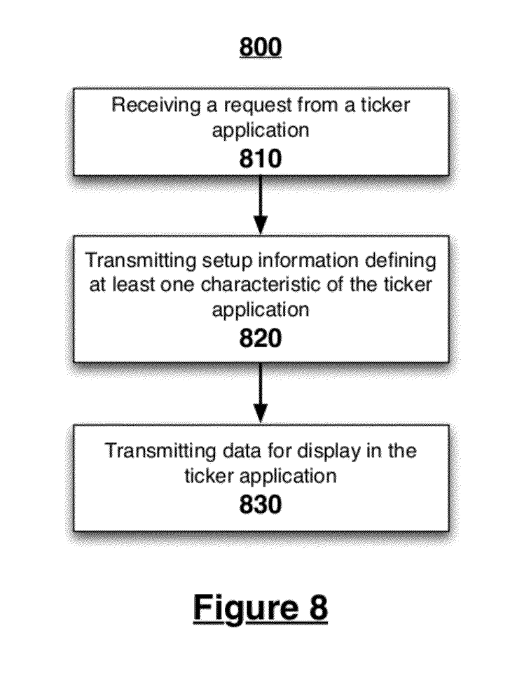

FIG. 9 is a block diagram of a method 900 for responding to a request from a ticker application for a data feed to display in the ticker application. In embodiments, the method 900 may be implemented by a software application on a general-purpose computer or a server computer. For example, the method 900 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a content provider receives 910 a request from a ticker application, the request comprising an identifier. In embodiments, the identifier is data that may be used by the content provider to aggregate information relevant to the identifier. Examples identifiers include, but are not limited to, a user identifier, such as a username, email address or other data that identifies a particular user to the content provider; a content identifier, which comprises data that identifies content being viewed by the user, such as the name or channel of the current program being viewed or other metadata identifying the subject matter of the content being viewed; a location identifier comprising data about the user's location, such as the country, state, city, etc. of the user; a demographic identifier that comprises data about the user, such as age, gender, race, etc.; a behavior identifier that comprises data regarding the user's viewing habits or behavior, such as the particular channel(s), show(s), etc. most watched by the user, the most common time of day for the user to watch content, or the amount of time a user views content during a given period of time; or a preferences identifier that comprises data defining content of interest to the user (e.g. the user is interested in sports, history, cooking or business news).

In embodiments, the content provider generates 920 a custom feed based on the received identifier. For example, the identifier within a request sent to a Twitter-related content provider may comprise a user identifier, such as a username. The Twitter-related content provider may aggregate all of the messages or “tweets” from those being followed by user identified in the request. The tweets may be configured into a custom feed. As another example, a sports-related content provider may receive a username in a request and generate a custom sports-related feed for the identified user. In embodiments, the user identifier may be used to locate previously configured preferences entered by the user that may be used to customize the feed. For example, the user may have previously indicated to the content provider a preference to only receive scores and/or news items related to one or more particular sports, leagues and/or teams.

As another example, the identifier within the request may comprise a content identifier, such as the name of the current television show being watched by the user. In embodiments, the content provider may aggregate content, such as social media (e.g., Twitter, Facebook, Google+, etc.) posts related to the current show, the schedule for future episodes of the show, information about the actors and/or subject matter of the show into a custom feed that is streamed to the ticker application for display.

As another example, the identifier may comprise a location identifier comprising information about the location of the user. For example, the identifier may comprise the country, state, city or neighborhood of the user. In embodiments, the location information is used to locate content relevant to the user's location that is incorporated into the custom feed. For example, the user's location may be used to locate local news and/or weather information to include in the custom feed. As another example, the location information may be used to identify advertisements from local establishments to include in the custom feed.

As another example, the identifier may comprise a preferences identifier. In embodiments, the preferences identifier may comprise one or more user interests, such as the user's favorite food, or the user's favorite sport and/or team, topics of interest to the user (e.g. business news, sports, history, food, cooking, etc.). The content provider may aggregate content based on the user preferences to generate a custom feed for the user.

As another example, the identifier may comprise a demographic identifier comprising demographic information about the user. Examples include, but are not limited to, the users gender, age, race, and/or occupation. In embodiments, this demographic information may be used to customize a feed for the user.

In embodiments, the content provider may aggregate content from multiple sources into a feed for the user. For example, a fantasy football content provider may aggregate Twitter and/or Facebook posts from the respective sources into a feed along with data related to the user's fantasy league scores, statistics, matchups, etc. that may be hosted on the content provider's servers.

In embodiments, the content provider transmits 930 data associated with the custom feed for display in the ticker application. As discussed previously, the data may comprise interactive and/or non-interactive elements that are to be displayed to the user in the ticker application.

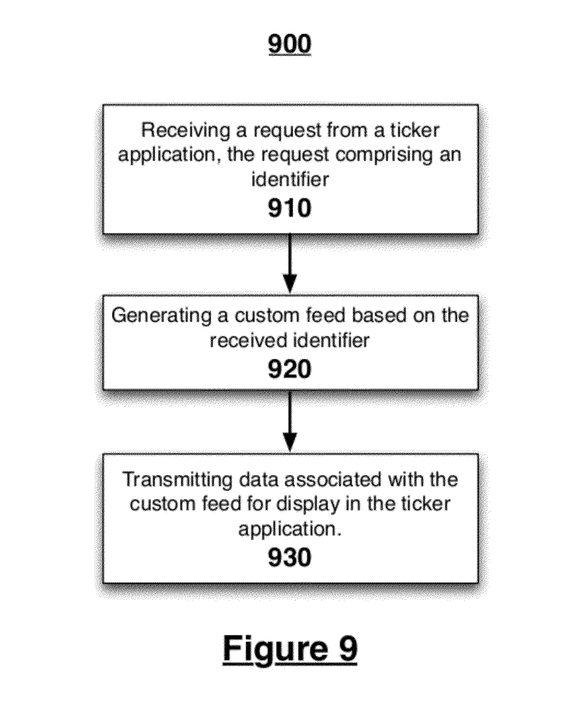

FIG. 10 is a block diagram of a method 1000 for displaying a feed in a ticker application according to embodiments of the invention. In embodiments, the method 1000 may be implemented by a software application on a general-purpose computer or a ticker device. For example, the method 1000 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, responsive to a user action, the ticker application displays 1010 a plurality of available feeds to a user. For example, in embodiments, a list of feeds may be displayed to a user as shown in FIG. 6A in response to a user selection of a static field within the ticker application. One skilled in the art will recognize that there are other user actions that could be used to trigger a display of a list of available feeds to a user, such as user interactions with a remote control.

In embodiments, responsive to a user selection of a feed, the ticker application transmits 1020 a request to a host associated with the selected feed. In embodiments, the request may optionally comprise an identifier. Example identifiers were discussed previously. In embodiments, the host uses the received identifier to generate a custom data feed for the requestor. In embodiments, the host is a server that generates the feed from data stored on the server or otherwise accessed by the server.

In embodiments, the ticker application receives 1030 data associated with the selected feed from the host. In embodiments, the data comprises a stream of information that is continuously received at the ticker application. In embodiments, the data associated with the selected feed may be transmitted from the host as one or more documents, such as XML files, RSS feeds, spreadsheet documents, etc., that are parsed by the ticker application to obtain the data to display in the ticker. As described previously, the data may comprise interactive and/or non-interactive elements.

In embodiments, the ticker application outputs 1040 the received data that is associated with selected feed for display to the user.

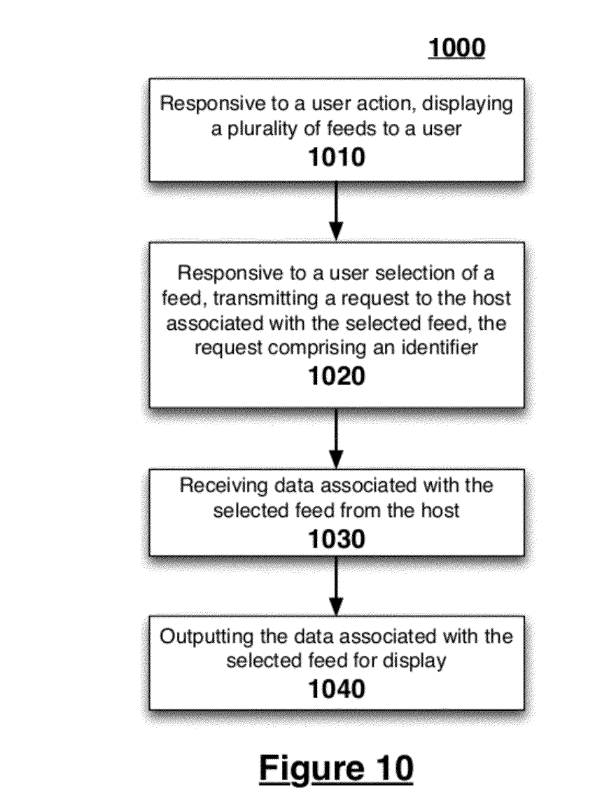

FIG. 11 is a block diagram of a method 1100 for switching a feed in a ticker application according to embodiments of the invention. In embodiments, method 1100 may be implemented by a software application on a general-purpose computer or a ticker device. For example, the method 1100 may be implemented as a series of computer instructions that are stored on a non-transitory computer readable medium, such as a memory device, that are processed by a processor (e.g. central processing unit (CPU)) of the computing device. Examples of a non-transitory computer readable medium include, but are not limited to, magnetic recording media (e.g. hard disk drives and magnetic tape), solid-state memory (e.g. flash memory, etc.), volatile memory (e.g. DRAM, SRAM, etc.) and optical media (e.g. CD-ROM, DVD, Blu-ray, etc.).

In embodiments, a ticker application receives 1110 a request from a user for a new feed to be displayed in the ticker application. As discussed previously, in embodiments, a list of available feeds may be displayed to a user in response to a user action, such as clicking a static field within the ticker or user interactions with a remote control (e.g. pressing one or more buttons of the remote). In embodiments, the ticker application receives a request for a new feed when the user selects a feed from the list that is different from the current feed being displayed in the ticker application.

In embodiments, the ticker application transmits 1120 a request to the host of the new feed. In embodiments, the request is transmitted to a server located on the Internet that hosts the feed. In embodiments, the data associated with the feed is streamed by the server to the ticker application for display in the ticker. In embodiments, the data is transmitted from the server as one or more documents, such as XML files, RSS feeds, spreadsheet documents, etc. that are parsed by the ticker application to obtain the data for display in the ticker.

In embodiments, the ticker application alters 1130 at least one characteristic of the ticker application in response to the user request for a new feed. Examples of the characteristics that may be changed include, but are not limited to, the color scheme of the ticker, a logo displayed in the ticker, the orientation of the ticker (e.g. horizontal or vertical), the font style/size/color, the layout of the ticker (e.g. one row, two rows, the number of fields, etc.), the data display type (e.g. scrolling from left to right, rolling from top to bottom, etc.), or the dimensions of the ticker on the screen. In embodiments, setup information defining one or more characteristics of the ticker for each feed is stored on the device and is accessed by the ticker application in response to the user selection of the corresponding feed.

In embodiments, setup information may be stored for various types of information that may be streamed by the content provider in the feed. In embodiments, the ticker application may detect the type of information within the stream and change the “look and feel” of the ticker accordingly. For example, a content provider of a sports-related feed may desire a different color scheme for basketball scores/news than is used for football scores/news. In embodiments, the ticker application detects when a change in the type of information within the feed occurs and alters at least one characteristic of the ticker accordingly. In embodiments, the content provider may include a change notifier within the feed between the end of the basketball scores/news and the football scores/news to notify the ticker application to alter at least one characteristic of the ticker.

In embodiments, setup information defining one or more characteristics of the ticker may be received from the host of the feed. For example, a server on the Internet that hosts a feed may transmit setup information associated with the feed as part of the stream of data for the feed. In embodiments, the ticker application receives the setup information and alters one or more characteristics of the ticker responsive to the received setup information. These embodiments provide the content providers with the ability to alter the “look and feel” of the ticker application by transmitting setup information defining the characteristics of the ticker at any time. This is advantageous as the content provider may alter the “look and feel” depending on the content being streamed for display. For example, a content provider of a sports-related ticker may want to use a different color scheme for basketball scores/news than is used for football scores/news. The host may transmit setup information in the feed between data associated with the basketball scores/news and the data associated with the football scores/news.

In embodiments, the ticker application receives 1140 data associated with the new feed from the host of the new feed. In embodiments, the ticker application receives the stream of data associated with the new feed from the hosting server associated with the new feed. In embodiments, the ticker application receives the feed data in one or more documents, such as XML files, RSS feeds, spreadsheet documents, etc., that are parsed by the ticker application to obtain the feed data to display in the ticker.

In embodiments, the ticker application outputs 1150 the data associated with the new feed for display in the ticker. As discussed previously, there are number of ways in which the data may be displayed within the ticker application, including a scrolling display of the streamed data within the ticker.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher-level code that are executed by a computer using an interpreter. Embodiments of the present invention may be implemented in whole or in part as machine-executable instructions that may be in program modules that are executed by a computer. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A method for displaying data in a ticker, the method comprising:
receiving first data associated with a first feed;
outputting the first data for display in the ticker on a display;
responsive to a user action, causing a plurality of feeds to be displayed on the display;
responsive to a user selecting one of the plurality of feeds, requesting second data associated with the selected feed;
receiving the second data; and
outputting the second data for display in the ticker on the display.

2. The method of claim 1 wherein the user action comprises clicking a portion of the ticker.

3. The method of claim 2 wherein the user action comprises clicking a static field of the ticker

4. The method of claim 1 wherein the user action comprises pressing a button on a remote control device.

5. The method of claim 1 wherein the data associated with the first feed is received from a first server on the Internet.

6. The method of claim 5 wherein the second data is requested from a second server on the Internet.

7. The method of claim 1 further comprising altering at least one characteristic of the ticker responsive to the selected feed.

8. The method of claim 7 wherein altering at least one characteristic of the ticker comprises changing a background color of at least a portion of the ticker.

9. The method of claim 7 wherein altering at least one characteristic of the ticker comprises changing a number of fields of the ticker.

10. The method of claim 1 wherein the request for the second data comprises a user identifier.

11. The method of claim 1 further comprising transmitting a termination request to a server streaming the first data.

12. A non-transitory computer readable storage medium storing one or more instructions, which when executed by one or more processors on a computing device, cause the computing device to perform a method comprising:
receiving first data associated with a first feed;
outputting the first data for display in a ticker on a display coupled to the computing device;
responsive to a user action, causing a plurality of feeds to be displayed on the display;
responsive to a user selecting one of the plurality of feeds, requesting second data associated with the selected feed;
receiving the second data; and
outputting the second data for display in the ticker on the display.

13. The computer readable storage medium of claim 12 further comprising one or more instructions for processing to the user action of clicking on a portion of the ticker.

14. The computer readable storage medium of claim 12 further comprising one or more instructions for processing to the user action of interacting with a remote control.

15. The computer readable storage medium of claim 12 further comprising one or more instructions for altering at least one characteristic of the ticker responsive to the selected feed.

16. The computer readable storage medium of claim 15 wherein altering at least one characteristic of the ticker comprises changing a background color of at least a portion of the ticker.

17. The computer readable storage medium of claim 15 wherein altering at least one characteristic of the ticker comprises changing a number of fields of the ticker.

18. The computer readable storage medium of claim 12 further comprising one or more instructions for transmitting a user identifier with the request for the second data.

19. The computer readable storage medium of claim 12 further comprising one or more instructions for transmitting a termination request to a server streaming the first data.

20. A graphical user interface comprising:
a first area displayed on a portion of a display that comprises a ticker for displaying first data associated with a first feed;
a second area, displayed responsive to a user action, that comprises a plurality of feeds that may be selected by a user, wherein second data associated with a feed selected from the plurality of feeds is displayed in the ticker of the first area.
